(19) United States
(12) Patent Application Publication
(10) Pub. No.: US 2011/0072414 A1
(43) Pub. Date: Mar. 24, 2011

(54) METHOD OF USING A DIAGRAM TO CREATE A PROGRAM CODE

(76) Inventor: Richard Dee Gardner, Scottsdale, AZ (US)

(21) Appl. No.: 12/563,143

(22) Filed: Sep. 20, 2009

(51) Int. Cl. G06F 9/44; G06F 3/048

(52) U.S. Cl. 717/109; 715/709; 717/125

(57) ABSTRACT

The method disclosed allows a user, such as a trader, to create a visual diagram of his/her trading strategy on a computer screen without actually writing any program code. The trading strategy can be created via a simple diagram. The instructions, the lines of code required to execute the process, can be created via a “wizard” or “strategy builder” so as to shield the user from entering many lines of instructions for the program code. The software program can be created by a user with little or no knowledge of programming where the program created performs a function without requiring the user to write the lines of code. Thus, a trader can create a program that he/she can use to create a trading strategy via a user editable diagram.

### BACKGROUND OF THE INVENTION

1. Field of the Invention

The present invention relates to a program for operating a computer and more specifically to a method of creating a software program consisting of one or more lines of code for a task by creating a visual diagram of the process for the task desired on a computer screen. The method disclosed allows a user to create a software program for operating a computer to perform a task without requiring the user to write or know how to write a complex program code.

### DESCRIPTION OF RELATED ART

A trading strategy is basically a set of rules that a computer interprets to automatically (or semi-automatically) place a trade or test trading rules using historic market data. Currently, traders are required to learn complex and often proprietary programming and scripting languages in order to create a trading strategy.

For example, suppose a trader develops a strategy such that if the price of a stock crossed above a 10-day average of the historic price, and if the stock's price increased above $40 a share, then 5 shares of the stock should be bought.

The trader is now required to write his idea in complex program code, for example:

if(LastPrice>Average(Price, 10) && LastPrice>40){ ExecuteOrder(Buy, 5);}
These instructions appear as Greek to individuals not trained in the programming language, and this is just an extremely simple example.

Often, programs consume several thousands lines of instructions. To prepare these many lines of code the trader must be trained in the programming language utilized by the underlying trading software in order to create a trading strategy. Often a code will not do exactly what it was written to do and the offending lines in the code must first be identified and must then be rewritten. Therefore, after the code is written it must be debugged. Debugging large strategies is usually extremely difficult and time consuming.

What is needed is a method that allows a person to create a software program that performs a function without requiring that user to write the lines of code, such as, for example, a method that a trader can use to create a trading strategy via a user editable diagram.

### SUMMARY OF THE INVENTION

In an exemplary embodiment of the present invention, there is disclosed a method of using a diagram to create a program code comprising the steps of:

selecting a first predefined function from one or more predefined conditions on a screen of a computer;

moving the selected first predefined function to a program building area on the screen of the computer;

selecting a second predefined function or operator from one or more predefined conditions on a screen of a computer;

moving the second selected predefined function or operator to a program building area on the screen of the computer;

locating said second selected predefined function or operator either above or below said first predefined condition;

selecting a third predefined function or operator from one or more predefined conditions on a screen of a computer;

moving the third selected predefined function or operator to a program building area on the screen of the computer; and

locating said third or an unlimited number of selected predefined “n” functions or operators to an appropriate place relative to said first and second predefined functions or operators;

wherein all of said functions or operators are collectively the program.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals.

FIG. 1 is a block diagram of an elementary trading strategy;

FIG. 2 is an example of a predefined condition for selection by a user;

FIG. 3 is the flow diagram of FIG. 1 being debugged;

FIG. 4 is a diagram of a new program created by a user that includes a function written for another program; and

FIG. 5 is a block diagram of a computer system for use with the present invention.

### DESCRIPTION OF THE PREFERRED EMBODIMENT

The method here described allows a person to create a strategy via a user-editable diagram. In the description of the invention that appears below, reference is made to a strategy or task that a trader has identified as being beneficial when trading shares of stocks, futures, options, forex or other securities. It is to be understood that this invention is not limited to a trader selling and buying stock.

Using the method described below, a trader can create a trading strategy for buying and selling stocks, futures, forex, options and so forth. The method can also be used for modifying existing orders, closing open orders and so forth (collectively, trading). The method also allows a trader to back test his/her ideas on historic market data to determine hypothetical profit potential of their strategies.

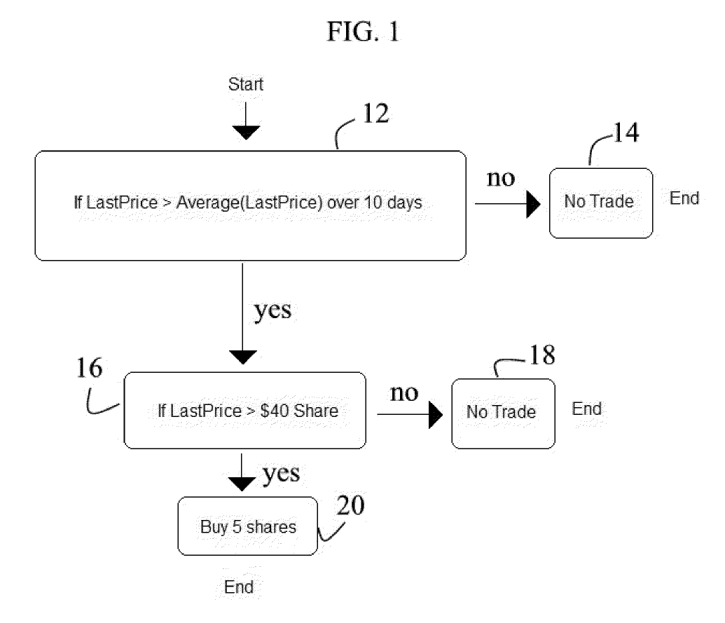

The method disclosed allows a trader to create a visual diagram of his/her trading strategy on a computer screen without actually writing any program code. The trading strategy can be created via a simple diagram as shown in FIG. 1 where, at start, block 12 is created which includes the step; If LastPrice>Average(LastPrice) over 10 days. If the result is NO, a trade is not made and the program advances to block 14 and ends. If the result is YES, the program advances to block 16 where it is determined If LastPrice>$40 Share. If the result is NO, the program advances to block 18, No Trade, and ends. If the result is YES, the program moves to block 20 where a decision is made to Buy 5 shares and the program ends.

The instructions, the lines of code required to execute the process in each block can be created via a “wizard” or “strategy builder” so as to shield the trader from entering many lines of instructions for the program code.

The process in which the wizard or strategy builder works is known by those skilled in the art. Thus, the user can specify his/her ideas via simple user input controls on the screen, by using buttons, text boxes, drop down menus, etc. rather than typing complex program code.

Below are provided various features of the method here disclosed.

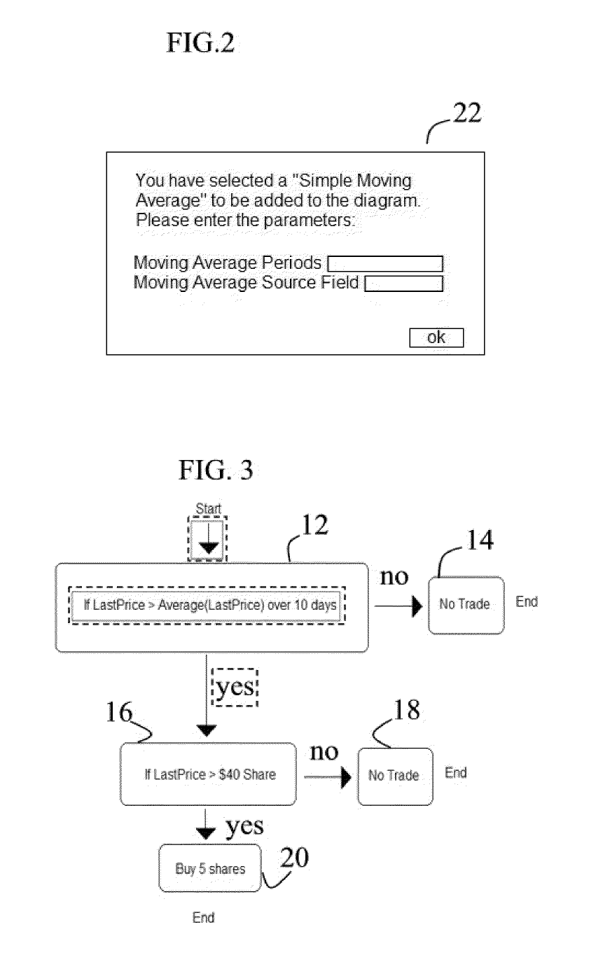

1. A user can select a predefined condition, formula or strategy from a “toolbox” area on the computer screen. A predefined formula might be a “Simple Moving Average”, which may open a dialog prompting the user to enter the required parameters. For example, referring to FIG. 2, the box 22 displayed on the computer screen may contain the following description;

You have selected a “Simple Moving Average” to be added to the diagram. Please enter the parameters:

Moving Average Periods______

Moving Average Source Field______
OK______

Now the user can move the item (hereafter referred to as a “condition box”) into place on the designer or canvas (the “designer” is a canvas area on the screen where the diagram is built). The user can use the mouse to move the condition box to the appropriate area and then “snap” the condition box into place on the designer or canvas, thereby adding a new box to the strategy diagram.

An unlimited number of conditions can be added to a diagram. When the screen area runs out of space the canvas may begin to scroll (horizontal and/or vertical scroll bars may display). All of the conditions added to the diagram are collectively known as the “program”. The user is effectively building a program visually even though he/she is not writing code in a programming language.

2. The “designer” dr “canvas” is initially an empty area on the screen where the diagram will be built by the user. Users may “step through” or “debug” a diagram as the program is being designed in this area.

When “stepping through” or “debugging” a program, the corresponding condition boxes in the diagram may be highlighted. For example, in FIG. 3, the user is debugging the program shown in FIG. 1, where and the first condition, block 12, is evaluated as YES. As the debugging progresses, the condition boxes are progressively highlighted and the result shown to the user:

This simple “debugging” feature allows a trader to test his idea as it is being built and again after it is completely built. This debugging feature may also report and display the program run time for each individual step in the program in minutes, seconds or milliseconds, and the total run time for the entire program, to provide a means to allow the user to optimize one or more steps of the program. In addition to debugging, the program can also be used for “back testing”. Back testing is where the entire trading strategy or a portion of it is tested against historic market data to determine the historic profit and loss, historic equity curve and various statistical calculations, which may allow the trader to identify if the trading strategy was historically profitable or unprofitable, and to what degree, based on historic market data or simulated market data.

3. The finished program can be utilized in many different ways. The underlying software may interpret the diagram directly and run the program by interpretation alone, or the program may be compiled into an intermediate language, such as a script, machine code, etc. The method for utilizing the program is dependent upon the chosen method of integration for this invention.

4. An important feature of the method disclosed is that the user is allowed to program in complex code if and when required. Although an important feature is to allow programs to be developed without requiring the user to write complex program code, the method of developing a program may make use of a complex program code under certain circumstances. Inherently, the diagram method disclosed is useful for interpreting functions but less useful for creating functions and variable assignments. The diagram is constructed based primarily upon predefined functions, such as the “SimpleMovingAverage” function referenced above. The function with inputs and output for “SimpleMovingAverage” may be defined in another program or in an actual program code. If the function is designed in complex program code (such as C++, Visual Basic, Java, or a scripting language for example), that function may be made available to the diagram designer. If the function is designed within the diagram itself, a new set of instructions are introduced.

5. Functions and variable assignments. A primary feature of the diagram interface is to interpret instructions. In the event that the user needs to create a function (which takes input(s) and provides output(s)) some ingenuity should be used. For example, a mathematical expression evaluator may be built into the diagram interpreter such that simple mathematical functions e.g. “A+B” or “SET A=A+B” may be processed. This way functions can be created such as [F(X,Y)]->[SET Y=X*Y]->[Return Y].

This function may be referenced from any program and the inputs for X and Y may be prompted when the user adds this function to the diagram. The output of Y will be returned to the program.

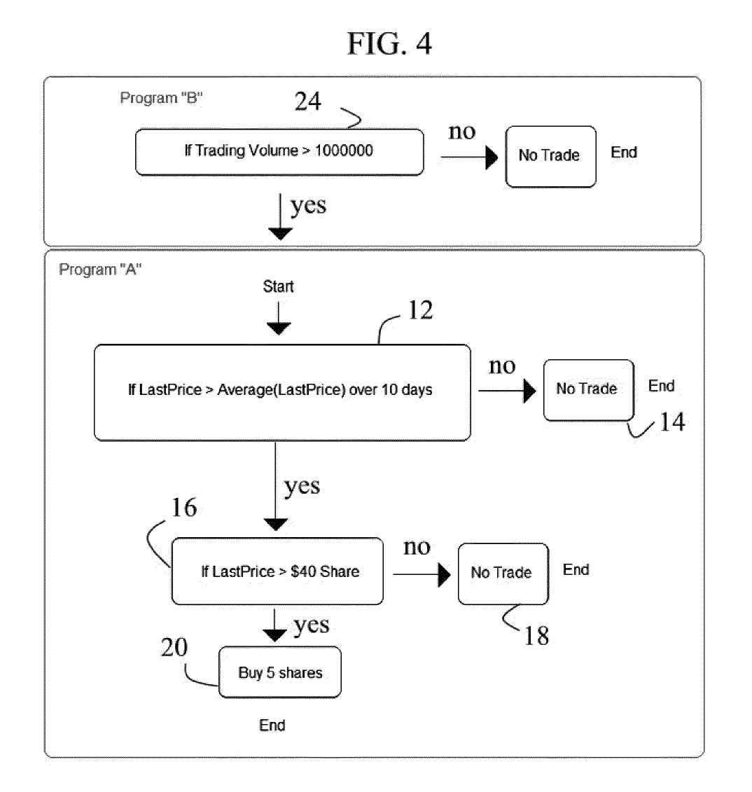

6. Modern software development makes use of what is known as “object oriented programming”. This method allows programmers to re-use commonly used parts of software code in one or more software applications. Entire programs or portions of programs can be saved and then later added to yet another program, or reused again in the same program being designed. For example, in FIG. 4, a new program is created while at the same time making use of the previously designed program of FIG. 1.

Referring to FIG. 4 as an input to the program of FIG. 1, there is added code for determining If Trading Volume>1,000,000, block 24. If the trading volume is less than 1,000,000 the program ends, NO block 26. If, however, trading volume is greater than 1,000,000 shares, YES, the program advances to demine If Last Price>Average(LastPrice) over 10 days, block 12.

7. The debugging/testing feature can be used to allow the user to debug or test his/her trading program on SIMULATED or HISTORIC data, so that no actual real trades are generated during the debugging or testing process.

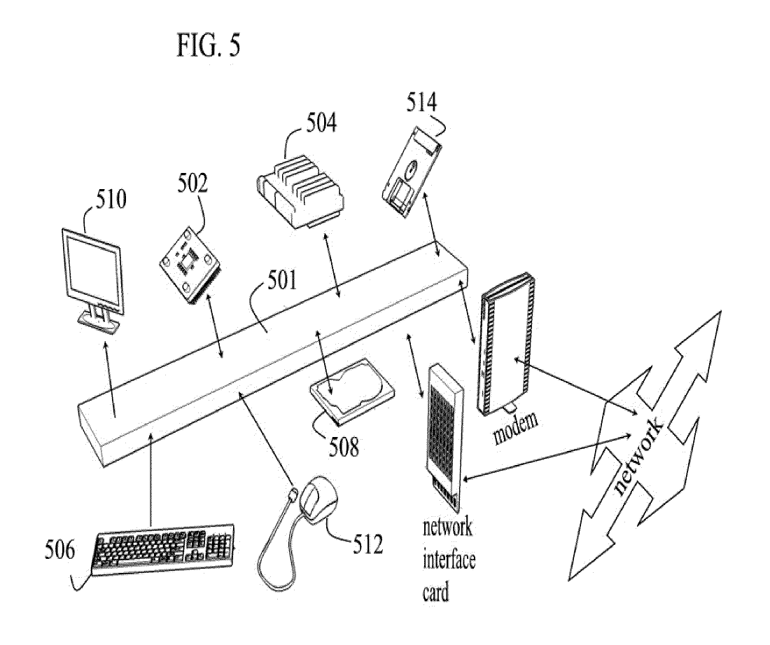

The present invention can be used on any properly configured general purpose computer system, such as the system shown in FIG. 5. Such a computer system 500 includes a processing unit (CPU) 502 connected by a bus to a random access memory 504, a storage device 508, a keyboard 506, a display 510 and a mouse 512. In addition, there is a device 514 for entry of data and software, including software embodying the present invention, into the system. An example of such a computer can be a Dell personal computer operating on the Microsoft Windows operating system, or Linux, Macintosh, etc. The invention can also be used on a laptop computer, cell phone, PDA, etc.

The various method embodiments of the invention will be generally implemented by a computer executing a sequence of program instructions for carrying out the steps of the method, assuming all required data for processing is accessible to the computer. The sequence of program instructions may be embodied in a computer program product comprising media storing the program instructions. As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the method, and variations on the method as described herein.

The present invention may be embodied as a system, method, or computer program product. Accordingly, the present invention may take the form of a hardware embodiment, a software embodiment, or an embodiment combining software and hardware. Furthermore, the present invention may take the form of a computer program product embodied in any tangible medium of expression having computer-usable program code embodied in the medium.

Any combination of one or more computer usable or computer readable medium(s) may be utilized. Specific examples of the computer-readable medium can include: a hard disk, a random access memory (RAM), a read-only memory (ROM), an erasable programmable read-only memory (EPROM), or Flash memory, a portable compact disc read-only memory (CD-ROM), etc. In the context of this document, a computer-usable or computer-readable medium may be any medium that can be used by or in connection with the instruction execution system or apparatus. Computer program code for carrying out operations of the present invention may be written in any combination of one or more programming languages. The program code may execute entirely on the user's computer, partly on the user's computer, as a stand-alone software package, partly on the user's computer and partly on a remote computer or entirely on the remote computer or server.

The present invention is described above with reference to a computer program products according to an embodiment of the invention. It will be understood that each block, and combinations of blocks shown, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart or blocks.

These computer program instructions may also be stored in a computer-readable medium that can direct a computer or other programmable data processing apparatus to function in a particular manner, such that the instructions stored in the computer readable medium produce an article of manufacture including instructions means which implement the function specified in the blocks.

The computer program instruction may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions specified.

The flowchart in the figure illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the flowchart illustration, and combinations of blocks in the flowchart illustration, can be implemented by special purpose hardware-based systems that perform the specified functions or acts, or combinations of special purpose hardware and computer instructions.

Based upon the foregoing, it will be apparent that there has been provided a new and useful method and system for using the Web.

In summary, the method disclosed when used by a trader, allows the trader to create a program to execute a trading strategy by means of a diagram that is designed visually, so that a computer may interpret the trading strategy or strategies and act upon the instructions.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A method of using a diagram to create a program code comprising the steps of:
selecting a first predefined function from one or more predefined conditions on a screen of a computer;
moving the selected first predefined function to a program building area on the screen of the computer;
selecting a second predefined function or operator from one or more predefined conditions on a screen of a computer;
moving the second selected predefined function or operator to a program building area on the screen of the computer;
locating said second selected predefined function or operator either above or below said first predefined condition;
selecting a third predefined function or operator from one or more predefined conditions on a screen of a computer;
moving the third selected predefined function or operator to a program building area on the screen of the computer; and
locating said third or an unlimited number of selected predefined “n” functions or operators to an appropriate place relative to said first and second predefined functions;
wherein all of said functions or operators are collectively the program.

2. The method of claim 1 wherein the instructions for each function are created via a wizard or query builder type of program to shield a user from entering program code.

3. The method of claim 2 wherein the functions are moved by a computer mouse.

4. The method of claim 3 wherein at least one of said functions is a condition.

5. The method of claim 4 wherein at least one of said functions is a formula.

6. The method of claim 4 wherein at least one of said functions is a strategy.

7. The method of claim 4 wherein an unlimited number of conditions can be added to the program.

8. The method of claim 7 wherein said program can be expanded vertically and or horizontally on the screen of the computer.

9. The method of claim 8 wherein said program can be stepped through or debugged as the program is being assembled or after it has been assembled.

10. The method of claim 9 wherein a condition can be highlighted as it is being debugged.

11. The method of claim 10 wherein the results of the debugging are displayed for the user to view.

12. The method of claim 9 wherein the runtime for each individual step is displayed for the user to view.

13. The method of claim 9 wherein the total runtime for the entire program is displayed for the user to view; wherein the user can optimize one or more steps of the program.

14. The method of claim 8 wherein said program can be used for back testing when used by a trader.

15. The method of claim 8 wherein the underlying software of said program may interpret the tasks directly and run the program by interpretation alone, or the program may be complied into an intermediate language.

16. The method of claim 15 wherein said intermediate language is script, machine code or their equivalent.

17. The method of claim 7 wherein said program is primarily based on predefined functions.

18. The method of claim 17 wherein the predefined function may be defined in another program developed using this invention or in traditional program code or script.

19. The method of claim 17 wherein a new set of instructions are introduced when the function is designed within the diagram itself.

20. The method of claim 18 wherein the program can be debugged and/or tested with simulated or historic data.
